(19) United States
(12) Patent Application Publication
(10) Pub. No.: US 2014/0187220 A1
(43) Pub. Date: Jul. 3, 2014

(54) GPS CONTROL IN A MOBILE DEVICE

(71) Applicant: INTERNATIONAL BUSINESS MACHINES CORPORATION, Armonk, NY (US)

(72) Inventors: David E. Bond, Raleigh, NC (US); John F. Davis, Durham, NC (US); Joel D. Diaz, Durham, NC (US)

(73) Assignee: International Business Machines Corporation, Armonk, NY (US)

(21) Appl. No.: 13/731,673

(22) Filed: Dec. 31, 2012

(51) Int. Cl. H04W 8/22; H04W 64/00

(52) U.S. Cl. CPC H04W 8/22; H04W 64/006
USPC 455/418

(57) ABSTRACT

Exemplary embodiments disclose a method, computer program product, and system for controlling a GPS receiver in a mobile device. In an exemplary embodiment, a mobile device receives a signal relating to a current date and time, and a signal relating to a current location of the mobile device. The mobile device determines if the current location of the mobile device is during daylight by comparing the current date and time to the sunrise and sunset time for the current location. The mobile device senses a light level by a light sensor of the mobile device to determine if light is present. The mobile device selectively enables the GPS receiver in the mobile device based on the light level, the current location of the mobile device, and the current date and time.

### FIELD OF THE INVENTION

The present invention relates generally to the field of mobile devices, and more particularly to global positioning system control in a mobile device.

### BACKGROUND OF THE INVENTION

The demand for more functionality in mobile devices, such as cellular telephones, constantly rises. Typically, more functionality in mobile devices means that the mobile device needs more power to function. Inherently, mobile devices have a limited power supply due to the use of a battery. Conservation of battery power is important to increase the operating duration of the mobile device. Activating a GPS receiver for the mobile device may dissipate a significant amount of power and therefore decreases the operating time of the mobile device.

### SUMMARY

Embodiments of the present invention disclose a method, computer program product, and system for controlling a GPS receiver in a mobile device. In an exemplary embodiment, a mobile device receives a signal relating to a current date and time, and a signal relating to a current location of the mobile device. The mobile device determines if the current location of the mobile device is during daylight by comparing the current date and time to the sunrise and sunset time for the current location. The mobile device senses a light level by a light sensor of the mobile device to determine if light is present. The mobile device selectively enables the GPS receiver in the mobile device based on the light level, the current location of the mobile device, and the current date and time.

### BRIEF DESCRIPTION OF THE SEVERAL VIEWS OF THE DRAWINGS

FIG. 1 is a block diagram illustrating a receiver controlling system environment, in accordance with an embodiment of the present invention.

FIG. 2 is a flowchart depicting operational steps of a receiver controlling program within the receiver controlling system environment of FIG. 1 in accordance with an embodiment of the present invention.

FIG. 3 depicts a block diagram of components of a mobile device executing the receiver controlling program, in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

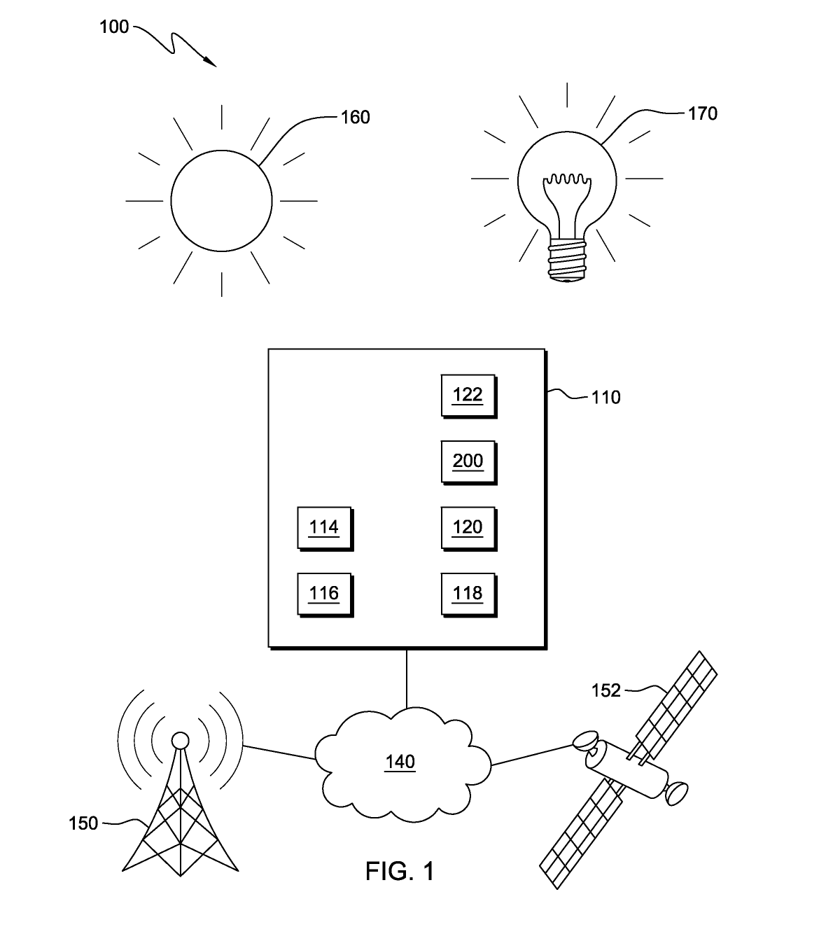

The present invention will now be described in detail with reference to the Figures. FIG. 1 is a block diagram illustrating a receiver controlling system environment, generally designated 100, in accordance with an exemplary embodiment of the present invention.

Receiver controlling system environment 100 includes a mobile device 110, a base transceiver station (BTS) 150, and a GPS satellite 152, all interconnected over network 140, and a natural light source 160 and an ambient light source 170.

Mobile device 110 may be a smart phone, a laptop computer, tablet computer, netbook computer, personal computer (PC), a desktop computer, a personal digital assistant (PDA), or any programmable electronic device capable of communicating with BTS 150 and GPS satellite 152, via network 140.

In exemplary embodiments, mobile device 110 includes a transmitter 114 and a receiver 116 to allow transmission and reception of data, such as audio communications between mobile device 110 and a remote location, such as BTS 150 and/or GPS satellite 152. Transmitter 114 and receiver 116 may be combined into a transceiver (not shown) in some exemplary embodiments. Exemplary embodiments of mobile device 110 may include an antenna (not shown) that is electrically coupled to the transceiver. Depending on the type of mobile device, the antenna may be internal or external to the housing of the mobile device.

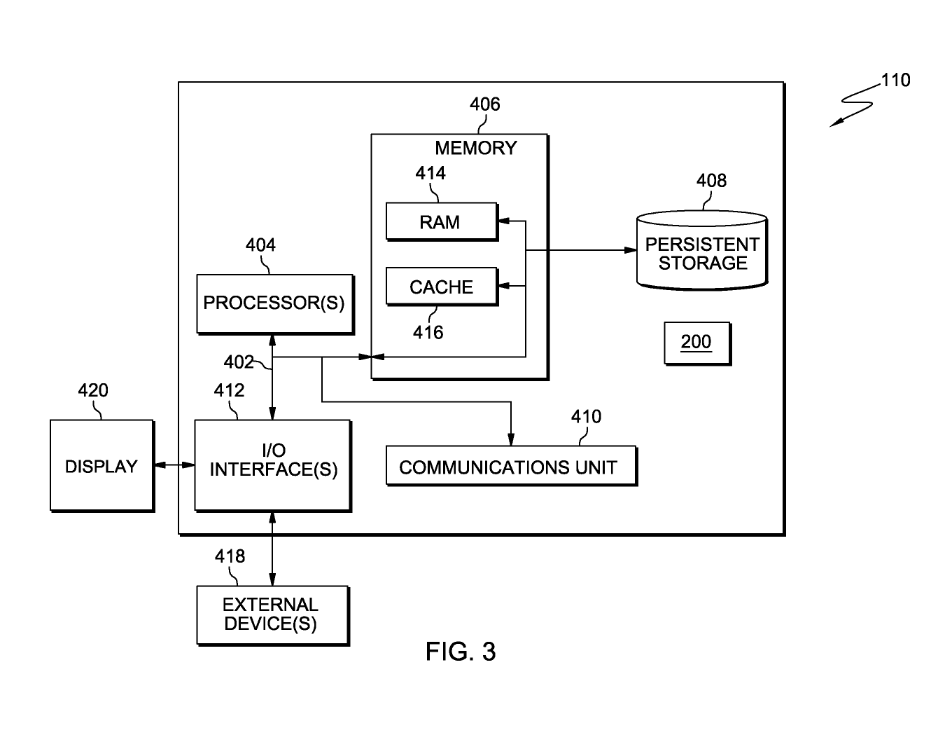

In exemplary embodiments, mobile device includes a timer 118, which may be included in a central processing unit (CPU), which will be discussed in more detail regarding FIG. 3. As will be discussed in further detail, mobile device 110 may use timer 118 to determine the current time and date.

In exemplary embodiments, mobile device 110 includes a global positioning system (GPS) receiver 120. As is known in the art, GPS comprises a plurality of satellites orbiting the Earth, and/or a plurality of satellite towers. In an exemplary embodiment, GPS receiver 120 receives signals from some of the plurality of the orbiting satellites, and/or satellite towers. Based on the received signals, it is possible to determine the precise location of mobile device 110 through GPS receiver 120.

In exemplary embodiments, mobile device 110 includes a light sensor 122, which detects light levels and generates electrical signals related thereto. As will be described in greater detail below, receiver controlling program 200 receives the electrical signals from light sensor 122 and may selectively activate the GPS receiver 120 when established criteria are met. In exemplary embodiments, light sensor 122 facilitates the detection of artificial (e.g. man-made) light for operation of receiver controlling program 200 in mobile device 110. In exemplary embodiments, receiver controlling program 200 may process or interpret electrical outputs from light sensor 122 that is used to characterize ambient light in the surrounding environment of light sensor 122. In exemplary embodiments, the detection approach may facilitate the detection of indoor or outdoor conditions by distinguishing artificial light sources that are common to indoor environments, relative to natural light that is common to outdoor environments.

In exemplary embodiments, mobile device 110 includes a timer 118. Timer 118 is included in processor 404 in some exemplary embodiments of mobile device 110. As discussed later herein, receiver controlling program 200 may use timer 118 to determine the date and time. In exemplary embodiments, receiver controlling program 100 may use timer to selectively activate GPS receiver 120 when established criteria are met.

Mobile device 110 includes receiver controlling program 200. Receiver controlling program 200 may be implemented in a variety of ways. In an exemplary embodiment, receiver controlling program 200 receives a time-of-day message from the base transceiver station (BTS) 150 via cell site controller (not shown). The time-of-day message is used to set timer 118 or any other form of clock used in mobile device 110.

Receiver controlling program 200 uses the time-of-day, location of mobile device 110, and/or readings from light sensor 122 to selectively enable or disable GPS receiver 120. For example, receiver controlling program 200 enables GPS receiver 120 to operate during daylight hours when light sensor 122 detects light levels of ambient light. More information relating to possible scenarios when receiver controlling program 200 selectively enables or disables GPS receiver 120 will be discussed later herein.

Network 140 can be, for example, a local area network (LAN), a wide area network (WAN) such as the Internet, or a combination of the two, and can include wired, wireless, or fiber optic connections. In general, network 140 can be any combination of connections and protocols that will support communications between mobile device 110 and BTS 150 and GPS satellite 152.

Mobile device 110 may further include internal and external hardware components, as depicted and described in further detail with respect to FIG. 4.

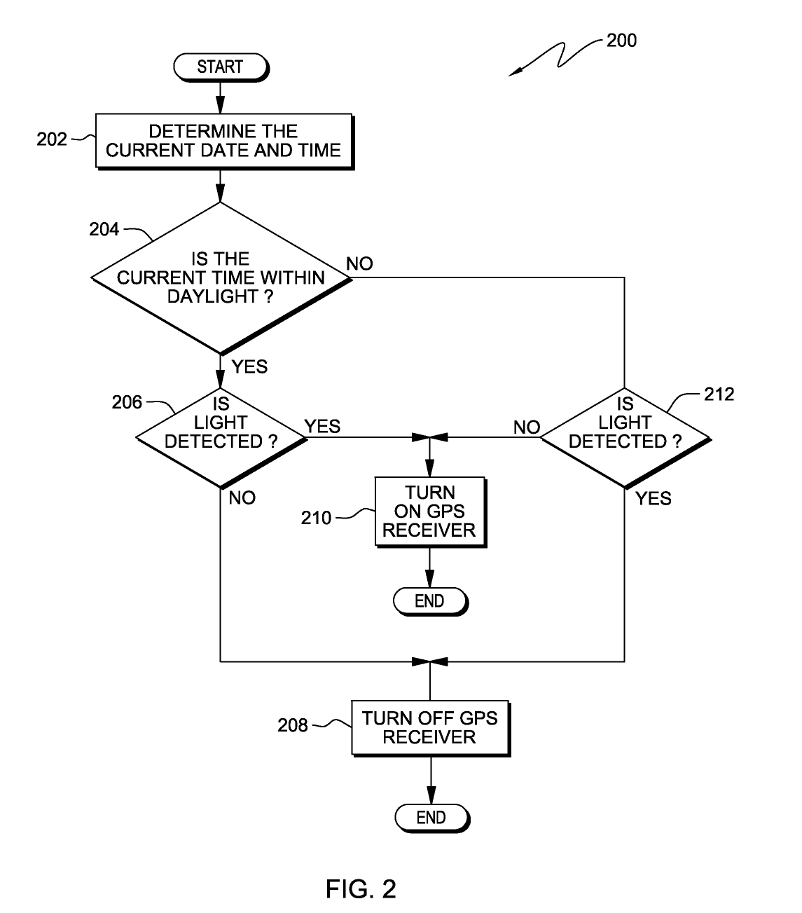

FIG. 2 is a flowchart depicting operational steps of receiver controlling program 200 for controlling a GPS receiver in a mobile device, in accordance with an embodiment of the present invention.

In step 202, receiver controlling program 200 determines the current date and time. In an exemplary embodiment, receiver controlling program 200 accesses the signals received through GPS receiver 120 from some of the plurality of the orbiting satellites, and/or satellite towers to determine the precise location of mobile device 110 through GPS receiver 120. In this exemplary embodiment, the receiver controlling program 200 accesses additional signals received that correspond to a current date and time of mobile device 110. In another exemplary embodiment, receiver controlling program accesses an internal clock and calendar integral to mobile device 110 to provide the current date and time of mobile device 110. In mobile device 110 that is already configured to receive time-of-day signals, receiver controlling program 200 may be readily implemented as a series of software instructions that utilize location data generated by the GPS receiver along or in combination with time-of-day messages received by mobile device 110.

In step 204, receiver controlling program 200 determines if the current time is within daylight of the current date. In an exemplary embodiment, receiver controlling program 200 compares the determined current date, time and location of mobile device 110 with information relating to the sunrise and sunset times for that current location. In an example, the information relating to the sunrise and sunset times for that current location may in the form of a table that stored in a file accessible by receiver controlling program remotely through network 140. In another example, the table is stored in memory of mobile device 110 and is accessible by receiver controlling program 200.

If receiver controlling program 200 determines the current time is within daylight of the current date, receiver controlling program 200 determines if light is detected (step 206). In an exemplary embodiment, receiver controlling program 200 processes or interprets electrical outputs from light sensor 122 that is used to characterize ambient light in the surrounding environment of light sensor 122. In exemplary embodiments, the detection approach may also facilitate the detection of indoor or outdoor conditions by distinguishing artificial light sources that are common to indoor environments, relative to natural light that is common to outdoor environments.

If receiver controlling program 200 determines that natural light is detected, receiver controlling program 200 turns off GPS receiver 120 (step 208).

If receiver controlling program 200 determines that light is not detected, receiver controlling program 200 turns on GPS receiver 120 (step 210).

If receiver controlling program 200 determines the current time is not within daylight of the current date, receiver controlling program 200 determines if light is detected (step 212).

If receiver controlling program 200 determines that light is detected, receiver controlling program 200 turns on GPS receiver 120 (step 210).

If receiver controlling program 200 determines that light is not detected, receiver controlling program 200 turns off GPS receiver 120 (step 208).

In an exemplary embodiment, receiver controlling program 200 may start and/or continue to run automatically when the location of mobile device 110 is in a location where it is daylight. In another exemplary embodiment, receiver controlling program 200 may start to run when GPS signals are detected by GPS receiver 120 of mobile device 110. In another exemplary embodiment, receiver controlling program 200 may start to run when mobile device 110 detects movement through an accelerometer or other similar sensor that detects motion of mobile device 110. In some exemplary embodiments, receiver controlling program 200 is activated by a manual command from a user through the user interface of mobile device 110.

In another exemplary embodiment, receiver controlling program 200 may start periodically after receiver controlling program 200 ceases operation. In an example, if GPS receiver 120 does not detect a GPS signal from a single satellite, then the receiver controlling program 200 may wait to start after an hour to see if a GPS signal is able to be received. In an example, mobile device 110 is in an automobile that is parked in a parking garage overnight. Every hour until sunrise, if light is not detected, receiver controlling program 200 may start but will not turn on the GPS receiver because a GPS signal is not detected. In this example, GPS receiver may be disabled and the GPS receiver may try and locate GPS signal after an hour delay. However, if the mobile device senses movement or use by a user, receiver controlling program 200 may start to operate.

Exemplary embodiments of receiver controlling program 200 in mobile device 110 provides intelligent control of the GPS receiver to potentially conserve electrical power. Exemplary embodiments may be implemented through the addition of software instructions alone to existing mobile devices, and may not require additional hardware modifications to mobile devices that already include a light sensor and GPS receiver. It should be noted that other forms of positioning, such as triangulation, timing signals, from a plurality of base stations transceiver stations, or other conventional positioning technology may be used in place of GPS technology and/or a GPS receiver.

FIG. 3 depicts a block diagram of components of mobile device 110 in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

Mobile device 110 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 414 and cache memory 416. In general, memory 406 can include any suitable volatile or non-volatile computer-readable storage media.

Receiver controlling program 200 is stored in persistent storage 408 for execution by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other data processing systems or devices, including resources of mobile device 110. In these examples, communications unit 410 includes one or more network interface cards. Communications unit 410 may provide communications through the use of either or both physical and wireless communications links. Receiver controlling program 200 may be downloaded to persistent storage 408 through communications unit 410.

I/O interface(s) 412 allows for input and output of data with other devices that may be connected to mobile device 110. For example, I/O interface 412 may provide a connection to external devices 418 such as a keyboard, keypad, a touch screen, and/or some other suitable input device. External devices 418 can also include portable computer-readable storage media such as, for example, thumb drives, portable optical or magnetic disks, and memory cards. Software and data used to practice embodiments of the present invention, e.g., receiver controlling program 200, can be stored on such portable computer-readable storage media and can be loaded onto persistent storage 408 via I/O interface(s) 412. I/O interface(s) 412 also connect to a display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for controlling a GPS receiver in a mobile device, the method comprising:
receiving a signal relating to a current date and time, and a signal relating to a current location of the mobile device;
determining if the current location of the mobile device is during daylight by comparing the current date and time to a sunrise time and a sunset time for the current location;
sensing a light level by a light sensor of the mobile device to determine if light is present; and
selectively enabling the GPS receiver in the mobile device based on the light level, the current location of the mobile device, and the current date and time.

2. The method of claim 1, further comprising accessing a storage device that includes the sunrise time and the sunset time for a location.

3. The method of claim 1, further comprising determining that the light that is present is artificial light.

4. The method of claim 3, wherein the GPS receiver in the mobile device is turned off when artificial light is present and the current location of the mobile is during daylight.

5. The method of claim 1, further comprising determining that the light that is present is natural light.

6. The method of claim 1, wherein the GPS receiver in the mobile device is not enabled when light is not present and the current location of the mobile is during daylight.

7. A computer program product for controlling a GPS receiver in a mobile device, the computer program product comprising:
one or more computer-readable storage media and program instructions stored on the one or more computer-readable storage media, the program instructions comprising:
program instructions to receive a signal relating to a current date and time, and a signal relating to a current location of the mobile device;
program instructions to determine if the current location of the mobile device is during daylight by comparing the current date and time to a sunrise time and a sunset time for the current location;
program instructions to sense a light level by a light sensor of the mobile device to determine if light is present; and
program instructions to selectively enable the GPS receiver in the mobile device based on the light level, the current location of the mobile device, and the current date and time.

8. The computer program product of claim 7, further comprising:
program instructions to access a storage device that includes the sunrise time and the sunset time for a location.

9. The computer program product of claim 7, further comprising:
program instructions to determine that the light that is present is artificial light.

10. The computer program product of claim 9, wherein the GPS receiver in the mobile device is turned off when artificial light is present and the current location of the mobile is during daylight.

11. The computer program product of claim 7, further comprising:
program instructions to determine that the light that is present is natural light.

12. The computer program product of claim 7, wherein the GPS receiver in the mobile device is not enabled when light is not present and the current location of the mobile is during daylight.

13. A computer system for controlling a GPS receiver in a mobile device, the computer system comprising:
one or more computer processors;
one or more computer-readable storage media;
program instructions stored on the computer-readable storage media for execution by at least one of the one or more processors, the program instructions comprising:
program instructions to receive a signal relating to a current date and time, and a signal relating to a current location of the mobile device;
program instructions to determine if the current location of the mobile device is during daylight by comparing the current date and time to a sunrise time and a sunset time for the current location;
program instructions to sense a light level by a light sensor of the mobile device to determine if light is present; and
program instructions to selectively enable the GPS receiver in the mobile device based on the light level, the current location of the mobile device, and the current date and time.

14. The computer system of claim 13, further comprising:
program instructions to access a storage device that includes the sunrise time and the sunset time for a location.

15. The computer system of claim 13, further comprising:
program instructions to determine that the light that is present is artificial light.

16. The computer system of claim 15, wherein the GPS receiver in the mobile device is turned off when artificial light is present and the current location of the mobile is during daylight.

17. The computer system of claim 13, further comprising:
program instructions to determine that the light that is present is natural light.

18. The computer system of claim 13, wherein the GPS receiver in the mobile device is not enabled when light is not present and the current location of the mobile is during daylight.
